(19) United States
(12) Patent Application Publication
(10) Pub. No.: US 2019/0300801 A1
(43) Pub. Date: Oct. 3, 2019

(54) STAGED REMOVAL OF AROMATICS IN NAPHTHA REFORMING

(71) Applicant: ExxonMobil Research and Engineering Company, Annandale, NJ (US)

(72) Inventors: Narasimhan Sundaram, Annandale, NJ (US); Hans Thomann, Bedminster, NJ (US); Edward W. Corcoran, JR., Nazareth, PA (US)

(21) Appl. No.: 16/357,670

(22) Filed: Mar. 19, 2019

Related U.S. Application Data
(60) Provisional application No. 62/650,411, filed on Mar. 30, 2018.

(51) Int. Cl. C10G 59/04; B01D 53/047; C10G 25/03; C10G 35/085; B01J 20/22; B01J 20/28

(52) U.S. Cl. CPC C10G 59/04; B01D 53/047; C10G 25/03; C10G 35/085; C10G 2300/4018; B01J 20/2803; B01D 2253/108; C10G 2300/1096; B01J 20/226

(57) ABSTRACT

Systems and methods are provided for performing multistage naphtha reforming with intermediate separation of aromatics using a swing adsorption process. Use of a swing adsorption process can allow aromatics to be selectively removed from the intermediate reforming effluent while reducing or minimizing the energy costs for cooling and subsequent reheating of the intermediate reforming effluent. The resulting aromatics-rich stream generated from swing adsorption can have a substantially higher aromatics content than an aromatics-rich stream generated by conventional separation methods during multi-stage naphtha reforming. In some aspects, selective thermal purging (either hot or cold) can be used to further facilitate adsorption or desorption of components by the adsorbent in the swing adsorption vessel.

### CROSS-REFERENCE TO RELATED APPLICATIONS

This application claims priority to U.S. Provisional Application Ser. No. 62/650,411 filed Mar. 30, 2018, which is herein incorporated by reference in its entirety.

### FIELD

In various aspects, the invention is related to integration of naphtha reforming with a swing adsorption process for intermediate removal of aromatics.

### BACKGROUND

Catalytic reforming is a well established refinery process for improving the octane quality of naphthas or straight run gasolines. Reforming can be defined as the total effect of the molecular changes, or hydrocarbon reactions, produced by dehydrogenation of cyclohexanes, dehydroisomerization of alkylcyclopentanes, and dehydrocyclization of paraffins and olefins to yield aromatics; isomerization of n-paraffins; isomerization of alkylcycloparaffins to yield cyclohexanes; isomerization of substituted aromatics; and hydrocracking of paraffins which produces gas, and inevitably coke, the latter being deposited on the catalyst. In catalytic reforming, a multifunctional catalyst is usually employed which contains a metal hydrogenation-dehydrogenation (hydrogen transfer) component, or components, usually platinum, substantially atomically dispersed on the surface of a porous, inorganic oxide support, such as alumina. The support, which usually contains a halide, particularly chloride, provides the acid functionality needed for isomerization, cyclization, and hydrocracking reactions.

Reforming reactions are both endothermic and exothermic, the former being predominant, particularly in the early stages of reforming with the latter being predominant in the latter stages. In view thereof, it has become the practice to employ a reforming unit comprised of a plurality of serially connected reactors with provision for heating of the reaction stream from one reactor to another. There are three major types of reforming: semiregenerative, cyclic, and continuous. Fixed-bed reactors are usually employed in semiregenerative and cyclic reforming and moving-bed reactors in continuous reforming. In semiregenerative reforming, the entire reforming process unit is operated by gradually and progressively increasing the temperature to compensate for deactivation of the catalyst caused by coke deposition, until finally the entire unit is shut-down for regeneration and reactivation of the catalyst. In cyclic reforming, the reactors are individually isolated, or in effect swung out of line, by various piping arrangements. The catalyst is regenerated by removing coke deposits, and then reactivated while the other reactors of the series remain on stream. The “swing reactor” temporarily replaces a reactor which is removed from the series for regeneration and reactivation of the catalyst, which is then put back in the series. In continuous reforming, the reactors are moving-bed reactors, as opposed to fixed-bed reactors, with continuous addition and withdrawal of catalyst and catalyst is regenerated in a separate regeneration vessel.

Through the years, many process variations have been proposed to improve aspects of the reforming process, such as C₅₊ liquid (a relatively high octane product stream) yield and/or octane quality of the product stream from catalytic reforming. For example, if a product of high octane is desired, e.g. 100 or higher RON (research octane number), the severity of reforming can be increased. This can generally be accomplished by reducing the space velocity or increasing reaction temperature. While increased severity for obtaining a higher octane product is desirable, it has disadvantages. For example, high severity usually: (i) reduces the yield of C₅⁺ as a percent of the naphtha feedstock; (ii) usually causes more rapid accumulation of coke on the catalyst, thus rapidly decreasing the activity of the catalyst and requiring more frequent regeneration.

In order to achieve higher yields of hydrogen and of C₅⁺ liquid as a percent of the naphtha feedstock, it can be desirable to conduct reforming in multiple stages and separate an aromatics-rich (high octane) stream between stages. The separation can be performed after reforming at low severity, in a first stage or stages, to convert most of the alkycyclohexanes and alkylcyclopentanes to aromatics with minimum conversion, especially cracking, of paraffins. The remaining paraffin-rich, or aromatics-lean stream can be processed in the downstream stage, or stages, at relatively high severity and preferably at relatively low pressures.

U.S. Pat. No. 4,972,967 describes systems and methods for performing naphtha reforming in a multi-stage system with separation of aromatic compounds between the stages. A first reforming stage can be operated at low severity. An intermediate separation stage can then be used, for example, to form an aromatics-lean stream and an aromatics-rich stream. The aromatics-lean stream can then be passed into a higher severity reforming stage. This can improve the overall increase in octane for the resulting reformed naphtha while reducing or minimizing coke formation during the reforming process. U.S. Pat. No. 4,872,967 describes performing a membrane separation to form the aromatics-lean and aromatics-rich streams. U.S. Pat. No. 5,211,838 also describes multi-stage naphtha reforming, but uses a boiling point-based separation to form a stream with reduced aromatic content for additional reforming in the second stage. While the processes in U.S. Pat. Nos. 4,872,967 and 5,211,838 are effective, still further improvements in naphtha reforming would be desirable. For example, it would be desirable to improve the interstage separation to further separate aromatics into a first stream and components for additional reforming into a second stream.

One option for performing a separation of gases containing small molecule components (such as CO, H₂S, H₂, CH₄, N₂, and others) is by use of an adsorbent bed that can selectively adsorb one or more components from a fluid. This provides a mechanism for the adsorbent to discriminate between different gases.

Different types of adsorbent beds are known. Typical adsorbents include activated carbons, silica gels, aluminas, and zeolites. In some cases, a polymeric material can be used as the adsorbent material. In any instance, the adsorbent bed preferentially adsorbs a more readily adsorbed component (known as the “heavy” gas) relative to a less readily adsorbed component (known as the “light” gas) of the gas mixture.

In order to effectuate the separation, adsorbent beds employ a highly porous microstructure. Gas molecules become attached to the surface area provided along the pores. The gas adsorbed on the interior surfaces of the micro-porous material may consist of a layer only one, or at most a few, molecules thick; however, surface areas of several hundred square meters per gram enable the adsorption of a significant portion of the adsorbent's weight in gas.

In addition to their affinity for different gases, zeolites and some types of activated carbons, called carbon molecular sieves, may utilize their molecular sieve characteristics to exclude or slow the diffusion of some gas molecules into their structure. This provides a mechanism for selective adsorption based on the size of the molecules. In this instance, the adsorbent bed restricts the ability of larger molecules to be adsorbed, thus allowing the gas to selectively fill the micro-porous structure of an adsorbent material with one or more species from a multi-component gas mixture.

Different adsorption techniques for gas separation are known. One adsorption technique is pressure swing adsorption, or “PSA.” PSA processes rely on the fact that, under pressure, gaseous contaminants tend to be adsorbed within the pore structure of an adsorbent material, or within the free volume of a polymeric material, to different extents. The higher the pressure in the adsorption vessel, the more gas is adsorbed.

When the adsorbent bed reaches the end of its capacity to adsorb contaminants, it can be regenerated by reducing the pressure. This causes the vessel to release the adsorbed components. A concentrated contaminant stream is thus released separate from the methane stream. In this way, the adsorption bed may be regenerated for subsequent re-use.

A related gas separation technique is temperature swing adsorption, or “TSA.” TSA processes also rely on the fact that gases tend to be adsorbed within the pore structure of micro-porous adsorbent materials or within the free volume of a polymeric material, to different extents. When the temperature of the adsorbent bed in the vessel is increased, the adsorbed gas molecules are released, or de-sorbed. By cyclically swinging the temperature of adsorbent beds within a vessel, TSA processes can be used to separate gases in a mixture.

An adsorbent bed system may rely on a plurality of beds in parallel to facilitate continuous operation in an efficient manner. The plurality of beds may be packed, for example, with activated carbons or molecular sieves. As an example, a first bed can be used for adsorption. This is known as a service bed. A second bed can undergo regeneration, such as through pressure reduction while the first bed is in service. Yet a third bed can be already regenerated and held in reserve for use in the adsorption system when the first bed becomes substantially saturated.

Some pressure swing adsorption systems can correspond to rapid cycle pressure swing adsorption systems. In the so-called “rapid cycle” processes, cycle times can be as small as a few seconds. A rapid cycle PSA (“RCPSA”) unit can be particularly advantageous, as such units are quite compact relative to normal PSA devices. Further, RCPSA contactors can enable a significant increase in process intensification (e.g., higher operating frequencies and gas flow velocities) when compared to conventional PSA.

U.S. Pat. No. 9,028,595 describes a process for separating methane from a natural gas mixture using pressure swing adsorption. The swing adsorption vessel includes an intermediate gas outlet to allow for removal of gas from the vessel at a location different from the ends of the vessel.

U.S. Pat. No. 9,795,915 describes a temperature enhanced pressure swing adsorption process with a reduced temperature differential between the adsorption and regeneration steps.

U.S. Patent Application Publication 2017/0354961 provides examples of materials with zeolitic framework structures that are bound with a mesoporous organosilica binder. U.S. Patent Application Publication 2016/0168485 describes formation of membranes from mesoporous organosilica materials.

U.S. Pat. No. 9,821,266 describes a pressure swing adsorption apparatus including multiple adsorbent beds that can rotate. A phase angle can be introduced between rotation of adsorbent beds to adjust the flow of fluids between beds.

### SUMMARY

In various aspects, a method is provided for catalytically reforming a naphtha boiling range hydrocarbonaceous feedstock. The method includes exposing a naphtha boiling range feedstock to a first reforming catalyst under first reforming conditions to form an intermediate reformer effluent comprising aromatics. At least a portion of the intermediate reformer effluent is passed into a vessel comprising an adsorbent bed. At least a portion of the aromatics from the intermediate reformer effluent are then adsorbed during an adsorbing step of a swing adsorption process to form an aromatics-lean stream. At least a portion of the aromatics-lean stream is exposed to a second reforming catalyst under second reforming conditions to form a second stage reformer effluent. At least a portion of the adsorbed aromatics are then desorbed to form an aromatics-rich purge stream.

In some aspects, the intermediate reformer effluent can include an aromatics content of 20 wt % to 40 wt %. Additionally or alternately, the aromatics-rich purge stream can include about 70 wt % or more of aromatics and/or the aromatics-rich purge stream can include about 70 wt % or more of the aromatics in the at least a portion of the intermediate reformer effluent.

In some aspects, the first reforming conditions can include a reactor pressure of about 200 kPa-g to about 7000 kPa-g. Additionally or alternately, the second reforming conditions can include a reactor pressure of about 200 kPa-g to about 1400 kPa-g. With regard to other reforming conditions, the first reforming conditions and/or the second reforming conditions can optionally further include a temperature of about 425° C. to about 650° C., a weight hourly space velocity (WHSV) of about 0.5 hr⁻¹ to about 20 hr⁻¹, and a hydrogen to oil ratio of about 1 to 10 moles of hydrogen per mole of C₅₊ feed.

In some aspects, the intermediate reformer effluent can be contacted with the adsorbent bed at an adsorber inlet temperature of about 100° C. to about 200° C. and an adsorber inlet pressure of about 200 kPa-g to about 2000 kPa-g. An average temperature of the adsorbent bed is optionally greater than the adsorber inlet temperature during the adsorbing step.

In some aspects, the adsorber inlet pressure can be reduced to from about 200 kPa-g to about 700 kPa-g during desorbing of the aromatics. Optionally, a temperature purge gas can be introduced during desorbing at an intermediate location in the adsorbent bed relative to the ends of the adsorbent bed. The temperature purge gas can be at a higher temperature than the temperature of the adsorbent bed at the intermediate location. Optionally, the temperature purge gas can be introduced into the adsorbent bed by passing the temperature purge gas through a cylindrical port into an opening in a cylindrical rotor.

Optionally, the method can further include introducing a cooling purge gas at the intermediate location a) after the desorbing and prior to a subsequent adsorbing, b) during adsorbing, or c) a combination thereof. Introducing the cooling purge gas at the intermediate location can optionally correspond to passing the cooling purge gas through a cylindrical port into an opening in a cylindrical rotor.

In various aspects, a system for performing multi-stage naphtha reforming is also provided. The system includes a first reforming stage including a first reforming catalyst, a first reforming stage inlet, and a first reforming stage outlet. The system further includes a swing adsorption stage including one or more swing adsorber vessels. The one or more swing adsorber vessels can include an adsorber inlet in fluid communication with the first reforming stage outlet, an adsorber outlet, an aromatics purge outlet, and an adsorbent bed. The aromatics purge outlet can be in fluid communication with an intermediate location of the adsorbent bed. The system further includes a second reforming stage including a second reforming catalyst, a second reforming stage inlet in fluid communication with the adsorber outlet and a second reforming stage outlet.

In some aspects, the swing adsorption stage can further include an intermediate purge inlet for introducing at least one of a temperature purge gas and a cooling purge gas into an intermediate location in at least one adsorbent bed in the one or more swing adsorber vessels. Optionally, the one or more swing adsorber vessels can further include a cylindrical rotor having one or more cylindrical rotor openings, and the intermediate purge inlet can be in intermittent fluid communication with the adsorbent bed via the one or more cylindrical rotor openings. Additionally or alternately, the one or more swing adsorber vessels can further include an axial rotor comprising one or more axial rotor openings, the adsorber inlet being in fluid communication with the adsorbent bed via the one or more axial rotor openings.

### BRIEF DESCRIPTION OF THE FIGURES

FIG. 1 is a perspective view of a pressure swing adsorption vessel as may be used in the processes described herein.

FIG. 2A is a perspective view of the adsorbent bed and flow channels suitable for use in a pressure swing adsorption vessel such as the vessel shown in FIG. 1.

FIG. 2B provides an exploded view of the adsorbent bed shown in FIG. 2A, including an exposed view of the intermediate gas inlet.

FIG. 2C is a longitudinal cross-sectional view of the adsorbent bed shown in FIG. 2A.

FIG. 3 is a perspective view of an adsorbent bed and flow channels for a pressure swing adsorption vessel such as the vessel shown in FIG. 1.

FIG. 4 shows examples of potential temperature profiles within an adsorbent bed at various points in time during a swing adsorption process for adsorption and desorption of aromatics from an intermediate reformer effluent.

FIG. 5 schematically shows an example of a system for multi-stage naphtha reforming with intermediate aromatics removal using a swing adsorption process.

FIG. 6 shows a perspective view of a reactor and adsorbent bed configuration suitable for performing swing adsorption.

FIG. 7 shows a side cross-sectional view of the reactor and adsorbent bed shown in FIG. 6.

FIG. 8 shows two top cross-sectional views of the reactor and adsorbent bed shown in FIG. 6.

### DETAILED DESCRIPTION OF THE EMBODIMENTS

In various aspects, systems and methods are provided for performing multistage naphtha reforming with intermediate separation of aromatics using a swing adsorption process. Use of a swing adsorption process can allow aromatics to be selectively removed from the intermediate reforming effluent while reducing or minimizing the energy costs for cooling and subsequent reheating of the intermediate reforming effluent. The resulting aromatics-rich stream generated from swing adsorption can have a substantially higher aromatics content than an aromatics-rich stream generated by conventional separation methods during multi-stage naphtha reforming. In some aspects, selective thermal purging (either hot or cold) can be used to further facilitate adsorption or desorption of components by the adsorbent in the swing adsorption vessel.

One of the difficulties with naphtha reforming is achieving improved octane while reducing or minimizing the amount of coke formation in the reforming process. Reducing the amount of aromatics present under high severity reforming conditions can assist with reducing or minimizing coke formation. However, conventional techniques are limited in the level of aromatics that can be selectively removed. Distillation techniques can be effective for removal of a substantial portion of the aromatics in an intermediate reformer effluent stream, but at the cost of also removing a substantial portion of the C₅₊ aliphatic compounds. This can limit the amount of octane improvement that can be achieved. Membrane processes can provide some selectivity, but the “aromatics-rich” stream can typically contain 50 wt % or more of non-aromatic compounds.

Removing aromatics from an intermediate reformer effluent using a swing adsorption process can overcome one or more of the above difficulties. Swing adsorption processes can provide increased degrees of selectivity relative to membrane separation of aromatics, such as providing an aromatics-rich purge stream containing 70 wt % aromatics or more, or 80 wt % or more. The relatively high concentration of aromatics in the aromatics-rich purge stream means that a reduced or minimized portion of the non-aromatic components from the intermediate reformer effluent are being added to the purge. This selectivity can allow an increased portion of the non-aromatic compounds to be exposed to additional naphtha reforming while further reducing or minimizing coke formation. Additionally, reducing or minimizing the aromatics content delivered to the second stage can facilitate using lower severity naphtha reforming conditions in the second stage.

An additional advantage of a swing adsorption process for aromatics separation can be the ability to reduce or minimize heating and cooling of the intermediate reformer effluent. Reforming processes are typically carried out at temperatures of 400° C. to 500° C. Membrane separations tend to be performed at temperatures near ambient, such as 50° C. or less. This means that performing a membrane separation between reforming stages can require a substantial amount of energy for cooling and then re-heating the intermediate reformer effluent. A swing to adsorption process for adsorbing aromatics from an intermediate reformer effluent can be performed at a higher temperature, such as a temperature between 100° C. and 200° C., or 120° C. to 180° C. This reduces the gap between the temperature of the reforming stages and the temperature of the intermediate separation. The inlet pressure during such adsorption can be about 200 kPa-g to about 2000 kPa-g, or about 30 kPa-g to about 200 kPa-g, or about 30 kPa-g to about 100 kPa-g. Because the pressure of the primary product stream from the swing adsorber can be comparable to the input pressure, performing the swing adsorption at such pressures can avoid the need to re-pressurize the output from the swing adsorber prior to the second reforming stage.

The input stream to an initial stage of reforming can have a wide range of aromatic content, such as an aromatics content of 1.0 wt % to 25 wt %, or 1.0 wt % to 20 wt %, or 5.0 wt % to 25 wt %, or 5.0 wt % to 20 wt %. Depending on the initial aromatics content, the severity of the initial stage of reforming can vary. For example, a lower severity of reforming conditions can be desirable for a naphtha stream having an aromatics content of 15 wt % or more, or 20 wt % or more. The initial reformer stage can both isomerize paraffinic hydrocarbons and form increased numbers of naphthenes and/or aromatics. After the initial stage of reforming, the intermediate reformer effluent can have an aromatics content of 20 wt % to 40 wt %.

The intermediate reformer effluent can then be passed into a swing adsorption stage for separation of an aromatics-lean stream and an aromatics-rich purge stream. The aromatics-rich purge stream from the swing adsorption stage can correspond to a high octane fraction, possibly suitable for inclusion in the gasoline pool and/or possibly suitable for further separations to recover desired aromatic components from the fraction such as toluene or xylenes. The aromatics-rich purge stream can include an aromatics content of 70 wt % or more, or 75 wt % or more, or 80 wt % or more, such as up to 90 wt % or possibly still higher. Additionally or alternately, the weight of aromatics in the aromatics-rich purge stream can correspond to 80 wt % or more of the aromatics in the intermediate reformer effluent, or 90 wt % or more. In other words, using a swing adsorber process to form the aromatics-rich purge stream can provide high selectivity for aromatics (i.e., an aromatics-purge stream with a high concentration of aromatics) while also providing high efficiency in separation (i.e., a substantial majority of the aromatics in the feed are separated into the aromatics-purge stream). The aromatics-lean stream can have a correspondingly reduced aromatics content. In some aspects, the aromatics content of the aromatics-lean stream can be 15 wt % or less, or 10 wt % or less.

During the swing adsorption process, the intermediate reformer effluent can be introduced into the swing adsorber vessel at a first pressure and a first temperature. During the adsorption step, the temperature of at least a portion of the adsorbent bed can increase to a second temperature where further adsorption of aromatics is reduced or minimized. After the adsorption step, desorption can be induced by reducing the pressure in the swing adsorber vessel. Additional desorption can be facilitated by using a hot temperature purge to increase the temperature of at least a portion of the adsorbent bed. Because temperature is being used to facilitate desorption, either a recycled portion of the aromatics-rich purge stream or a recycled portion of the aromatics-lean product stream can be a suitable purge stream.

One challenge in using a swing adsorption process for separation of aromatics from an intermediate reformer effluent can be the relatively high heat of adsorption of aromatic compounds in an adsorbent bed. Due in part to the higher molecular weight of aromatic compounds (as opposed to light gases such as methane, N₂, or CO), the heat of adsorption of aromatic compounds can tend to be larger, and possibly proportionally larger. As a result, during adsorption of aromatic compounds, a substantial amount of heat can be released in the adsorbent bed. As heat is released during adsorption, the temperature of the adsorbent to a point where little or no additional adsorption of aromatics can take place. This can potentially reduce the length of the adsorption step during a swing adsorption cycle. A similar type of heat management problem can also occur during regeneration of the adsorbent, due to the correspondingly large amount of heat that is required to desorb aromatic compounds from the adsorbent bed.

It has been discovered that the difficulties posed due to the large heat of adsorption of aromatic compounds can be overcome in part by using selective thermal purging of the adsorbent bed. In a conventional swing adsorption apparatus, all of the gas flows into the apparatus are introduced into one of the ends of the unit. This can include gas flows for increasing or decreasing the temperature of the adsorbent bed. However, the temperature profile of the adsorbent bed is typically not uniform. Therefore, introducing a gas flow for temperature control at the end of the unit can result in heating (or cooling) of portions of the adsorbent bed that are not directly involved in adsorption of aromatics. To overcome this difficulty, an intermediate entry point can be used to allow a hot purge or cold purge gas to be introduced into the adsorbent bed. Instead of attempting to heat or cool the entire adsorbent bed, the portion of the bed that is involved in equilibrium absorption of aromatics can be selectively heated or cooled, depending on whether the bed is in an adsorption step or a regeneration step.

Use of an intermediate hot and/or cold purge stream can also provide benefits relative to swing adsorber configurations that include heating or cooling elements in the adsorbent bed. The adsorbent bed in a swing adsorber typically corresponds to a porous material so that a substantial portion of the adsorbent capacity is located in the interior portions of the bed. Adding a heating or cooling system within the adsorbent bed can be effective for temperature management, but such a system can also consume a large percentage of the adsorbent bed volume. This can reduce the capacity of the adsorbent bed relative to the overall size of the swing adsorber vessel.

As used herein, the term “fluid” refers to gases, liquids, and combinations of gases and liquids, as well as to combinations of gases and solids, combinations of liquids and solids, and combinations of gases, liquids, and solids.

As used herein, the term “condensable hydrocarbons” means those hydrocarbons that condense at about 15° C. and one atmosphere absolute pressure. Condensable hydrocarbons may include, for example, a mixture of hydrocarbons having carbon numbers greater than 4.

As used herein, the term “pressure swing adsorption” shall be taken to include any one or more of the processes that employ a change in pressure for a purge cycle (e.g., PSA, PPSA, RCPSA, and RCPPSA).

In this discussion and the claims below, a zeolite is defined to refer to a crystalline material having a porous framework structure built from tetrahedra atoms connected by bridging oxygen atoms. Examples of known zeolite frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite can refer to aluminosilicates having a zeolitic framework type as well as crystalline structures containing oxides of heteroatoms different from silicon and aluminum. Such heteroatoms can include any heteroatom generally known to be suitable for inclusion in a zeolitic framework, such as gallium, boron, germanium, phosphorus, zinc, and/or other transition metals that can substitute for silicon and/or aluminum in a zeolitic framework.

### Swing Adsorber Conditions and Adsorbents

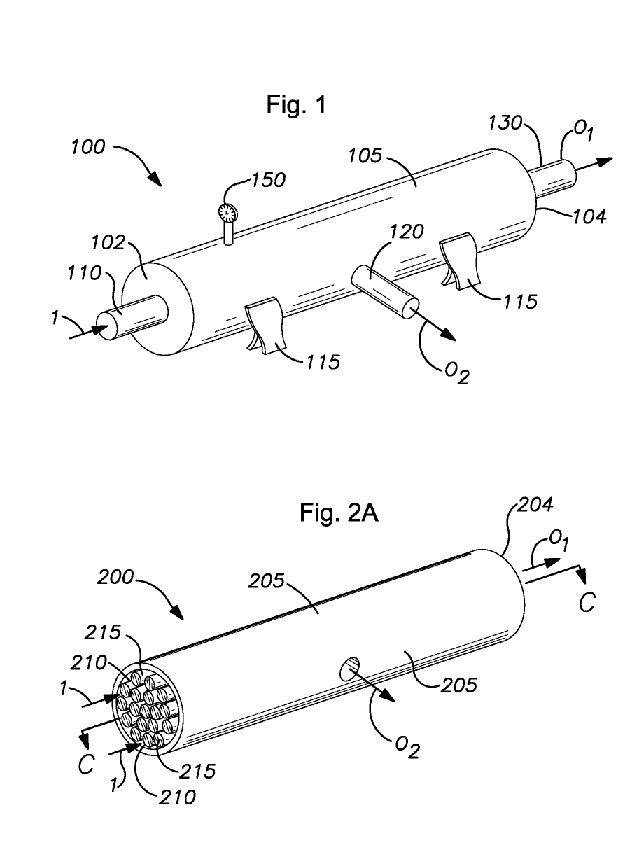

FIG. 1 is a perspective view of a pressure swing adsorption vessel 100. The vessel 100 is a contactor vessel, or “contactor,” that operates for the purpose of receiving an intermediate reformer effluent and separating the effluent into a aromatics-depleted stream and an aromatics-rich purge stream. The aromatics-depleted stream can be used, at least in part, as the input stream to a subsequent reformer stage. The aromatics-rich purge stream can be, for example, used as an aromatics stream and/or incorporated into the final reformed naphtha product.

The vessel 100 defines an elongated, pressure-containing body. The vessel 100 includes a housing 105. Preferably, the housing 105 is fabricated from iron or steel. In the arrangement of FIG. 1, the vessel 100 is illustrated in a substantially horizontal orientation. However, the vessel 100 may alternatively be operated in a vertical orientation. In either instance, the vessel 100 may include various supporting legs or pads 115.

The vessel 100 has a first end shown at 102, and a second end shown at 104. A gas inlet 110 is provided at the first end 102, while a first gas outlet 130 is provided at the second end 104. Optionally, a temperature purge gas inlet 120 is provided intermediate the first end 102 and the second end 104, or intermediate the gas inlet 110 and the first gas outlet 130.

In operation, the vessel 100 serves as a kinetic fractionator, or adsorbent contactor. A feed stream corresponding to an intermediate reformer effluent can be introduced into the vessel 100 through the gas inlet 110. Arrow “I” indicates the flow of fluid into the vessel 100. The natural gas is contacted within the vessel 100 by an adsorbent bed (not shown in FIG. 1). The adsorbent bed can selectively adsorb aromatics in preference to the paraffinic and naphthenic components in the intermediate reformer effluent.

It is understood that the vessel 100 can typically be part of a larger gas separation unit (not shown). The gas separation unit can include valving, vessels, and gauges as needed to carry out regeneration of the adsorbent bed and the capture of the separated gas components. Regeneration can be performed using pressure swing adsorption (PSA), optionally using rapid cycle PSA. Additionally or alternately, the regeneration can be performed using temperature swing adsorption (TSA), optionally using rapid cycle TSA

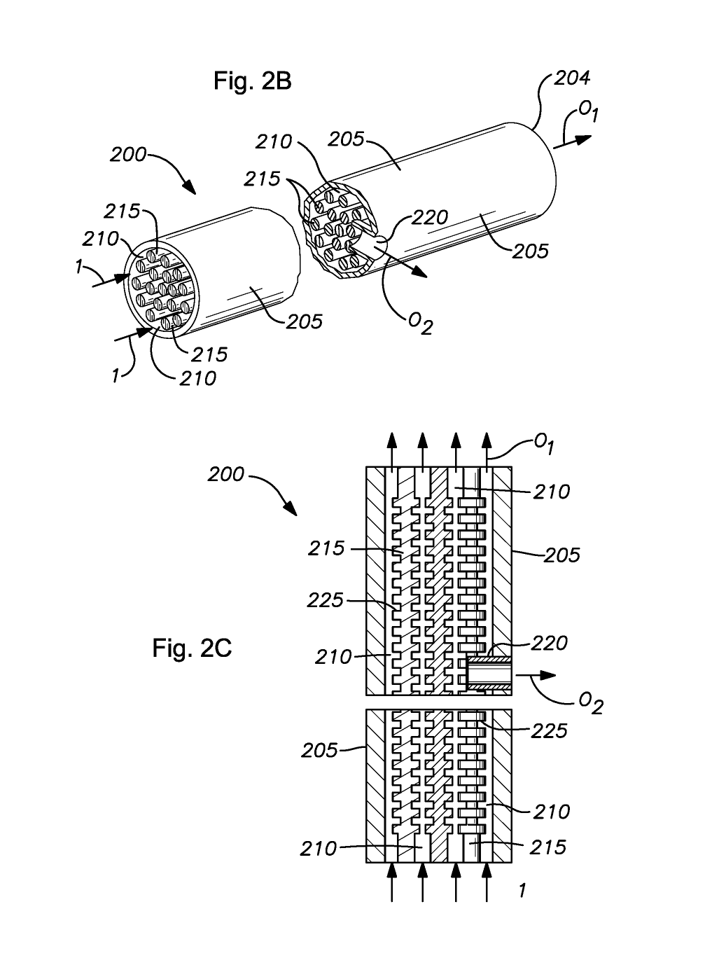

The vessel 100 utilizes an adsorbent bed to capture contaminants on the surface of a micro-porous adsorbent material and along the pore spaces therein. FIG. 2A is a perspective view of an adsorbent bed 200 according to some implementations. Here, the illustrative adsorbent bed 200 has an annular adsorbent ring 205. The adsorbent ring 205 is dimensioned to fit along an inner diameter of the housing 105 of the vessel 100 of FIG. 1. In various aspects, other convenient types of adsorbent bed configurations can be used instead of or in conjunction with the annular adsorbent ring configuration shown in FIG. 2A.

Within the adsorbent ring 205 is a plurality of adsorbent rods 215. The adsorbent rods 215 run substantially along the length of the adsorbent bed 200. This means that the rods 215 run essentially from the first end 102 to the second end 104 of the vessel 100. Flow channels 210 are provided between the adsorbent rods 215.

The adsorbent ring 205 and the adsorbent rods 215 are fabricated from a material that can selectively adsorb aromatics from an intermediate reformer stream that may contain aromatics, naphthenes, and paraffins. Because the input stream corresponds to an intermediate reformer effluent, the input stream can include a relatively low amount of nitrogen-containing and/or sulfur-containing compounds.

The adsorbent material can correspond to any convenient material that can preferentially adsorb aromatics. An example of a suitable material can be Y-zeolite. More generally, suitable adsorbents can include, but are not limited to, materials having a large pore zeolitic framework structure having a 12-member ring pore channel or larger, such as Y-zeolite; materials having a zeolitic framework structure corresponding to members of ITQ family such as ITQ-13; and materials having a zeolitic framework structure (such as any of the above noted zeolitic materials) that are bound with a mesoporous organosilica binder. U.S. Pat. No. 7,081,556 provides an example of a material including the ITQ-13 structure. U.S. Patent Application Publication 2016/0167032 provides examples of meosporous organosilica materials. U.S. Patent Application Publication 2017/0354961 provides examples of materials with zeolitic framework structures that are bound with a mesoporous organosilica binder. U.S. Patent Application Publication 2016/0168485 describes methods for forming membranes from a mesoporous organosilica structure.

The zeolite material and/or mesoporous material may be present in the adsorbent ring 205 and the adsorbent rods 215 in any suitable form. For example, zeolite material and/or mesoporous material may be in the form of beads that are packed to form the adsorbent material. Adsorbent beads, or aggregates, for swing adsorption processes are known in the art and can be of any suitable shape, including spherical or irregular. Adsorbent aggregates may be formed by adhering micro-porous zeolite crystals together with binder materials. The micro-pores exist due to the crystalline structure of the zeolitic framework material(s). The binder material is typically a dense material that does not have adsorptive properties, but which is used to bind the zeolite crystals. For refractory oxide binders, in order to function effectively, the size of binder particles must be smaller than the size of the individual zeolite crystals. For mesoporous binders, the high porosity of the binder can reduce or minimize diffusion resistance as aromatics travel toward the adsorption sites within the zeolie framework structure.

During a swing adsorption process, a feed stream “1” can be injected into the contactor 100 and will be passed across the adsorbent material. The adsorbent material can preferentially adsorb aromatics relative to paraffins and/or naphthenes in the feed stream. In order to characterize the ability of a material to selectively adsorb aromatics versus paraffins and/or naphthenes, the single component diffusion coefficient for benzene can be compared with cyclohexane and n-hexane. Although benzene is sometimes a less desirable component in gasoline, for purposes of determining the effectiveness of an adsorbent, benzene, cyclohexane, and n-hexane can serve as representative compounds for the types of components present in an intermediate reformer effluent stream. Thus, if an adsorbent has a suitable ratio of single component diffusion coefficients for benzene versus cyclohexane and/or n-hexane, this can be indicative of a material that can generally provide selective adsorption of naphtha boiling range aromatics relative to naphtha boiling range naphthenes and/or paraffins. In some aspects, the ratio of single component diffusion coefficients for benzene and cyclohexane (i.e., D_{C6H6}/D_{C6H12}) can be 5 or more, or 10 or more, or 25 or more, such as up to 50 or possibly still higher. Additionally or alternately, the ratio of single component diffusion coefficients for benzene and n-hexane (i.e., D_{C6H6}/D_{C6H14}) can be 5 or more, or 10 or more, or 25 or more, such as up to 50 or possibly still higher.

Single component diffusion coefficients are taken to be transport diffusion coefficients measured for a pure gas in the Henry's law regime of the adsorption isotherm. The loading of molecules in the zeolite is low in the Henry's law regime and in this regime the Fickian and Stephan-Maxwell diffusion coefficients are nearly equal. The mathematics supporting the analysis of diffusion coefficients is described more fully below.

In some implementations of the adsorbent bed 200, a magnetic material may be incorporated into the adsorbent rods 215. For example, each rod 215 may have an inner bore, and a magnetic material may be placed along the inner bore. The rods 215 may then be subjected to a magnetic or an electromagnetic field during packing. The magnetic field causes the rods 215 to repel one another, thereby assuring uniform spacing between the rods 215. Uniform packing of rods 215 is particularly important for kinetic and fast cycled adsorption processes so that gas components are not preferentially driven through one flow channel 210 over another.

In one aspect, a magnetic or electromagnetic field is applied during each adsorbent loading cycle. This aids in the separation of the rods 215. Application of the magnetic field may further provide for a homogeneous orientation of the zeolite material. Optionally, the magnetic field may be applied during the cycles themselves.

Referring again to FIG. 2A, within the annular adsorbent ring 205 and between the adsorbent rods 215 is a plurality of flow channels. The flow channels are seen at 210. The flow channels 210 define major flow channels that flow along a major axis of the adsorbent bed 200.

The flow channels 210 create a type of structured adsorbent contactor referred to as a “parallel channel contactor.” Parallel channel contactors are a subset of adsorbent contactors comprising structured (engineered) adsorbents in which substantially parallel flow channels are incorporated into the adsorbent structure. The flow channels 210 may be formed by a variety of means, some of which are described in U.S. Pat. Publ. No. 2008/0282887 titled “Removal of CO₂, N₂, and H₂S from Gas Mixtures Containing Same,” which is incorporated herein by reference for the limited purpose of describing formation of flow channels.

The adsorbent material forming the annular ring 205 and the rods 215 has a “kinetic selectivity” for two or more gas components. As used herein, the term “kinetic selectivity” is defined as the ratio of single component diffusion coefficients, D (in m²/sec), for two different species. The single component diffusion coefficients are also known as the Stefan-Maxwell transport diffusion coefficients that are measured for a given adsorbent for a given pure gas component. Therefore, for example, the kinetic selectivity for a particular adsorbent for a component A with respect to a component B would be equal to DA/DB.

The single component diffusion coefficients for a material can be determined by tests known in the adsorptive materials art. The preferred way to measure the kinetic diffusion coefficient is with a frequency response technique described by Reyes, et al. in “Frequency Modulation Methods for Diffusion and Adsorption Measurements in Porous Solids,” J. Phys. Chem. B. 101, pages 614-622 (1997), which is incorporated herein by reference. In the kinetically controlled separation for the vessel 100, it is preferred that kinetic selectivity (i.e., DA/DB) of the selected adsorbent for the first component (e.g., CO₂) with respect to the second component (e.g., methane) be greater than 5.

The term “selectivity” as used herein is based on a binary comparison of the molar concentration of components in the feed stream and the total number of moles of these components adsorbed by the particular adsorbent during the adsorption step of the process cycle under the specific system operating conditions and feed stream composition. For a feed containing a component A, a component B, and optionally additional components, an adsorbent that has a greater “selectivity” for component A than component B will have at the end of the adsorption step of the swing adsorption process cycle a ratio:

U_{A}=(total moles of A in the adsorbent)/(molar concentration of A in the feed) that is greater than the ratio:

U_{B}=(total moles of B in the adsorbent)/(molar concentration of B in the feed)

where: U_{A} is the “Adsorption Uptake of component A,” and U_{B} is the “Adsorption Uptake of component B.”

Therefore, for an adsorbent having a selectivity for component A over component B that is greater than one:

Selectivity=U_{A}/U_{B} (where U_{A}>U_{B}).

Amongst a comparison of different components in an intermediate reformer effluent, the component with the smallest ratio of the total moles picked up in the adsorbent to its molar concentration in the feed stream is defined as the “lightest component” in the swing adsorption process. The light component is taken to be the species, or molecular component, that is not preferentially taken up by the adsorbent in the adsorption process. This means that the molar concentration of the lightest component in the stream coming out during the adsorption step is greater than the molar concentration of that lightest component in the feed stream. It is noted that this definition for the lightest component may differ from a definition of lightest component based on molecular weight. In the present disclosure, the adsorbent contactor 100 can have a selectivity for adsorption of a first component (e.g., aromatics such as C₆H₆) over adsorption of a second component (e.g., naphthenes such as C₆H₁₂ or paraffins such as C₆H₁₄) of at least 5, more preferably a selectivity for a first component over a second component of at least 10, and most preferably a selectivity for a first component over a second component of at least 25.

Note that it is possible to remove two or more heavy components simultaneously. In various aspects, an intermediate reformer effluent can typically include a mixture of single-ring aromatics which can preferentially be adsorbed by the adsorbent relative to the mixture of other naphthenic and/or paraffinic components. However, for convenience the heavy component or components that are to be removed by selective adsorption will mostly be referred to herein as a single component.

Recovery of the light component(s) and/or the heavy components may also be characterized based on the concentration of components in the output streams from the swing adsorption system. In particular, the aromatics concentration in the input stream to the second reforming stage and the aromatics concentration in the purge stream from the swing adsorber can be used to characterize the effectiveness of the swing adsorption process. The weight percentage of aromatics in the input stream to the second (or other later) reformer stage can indicate the effectiveness of the swing adsorption process for reducing or minimizing the amount of aromatics that remain in the input stream. The weight percentage of aromatics in the purge stream from the swing adsorber can indicate the amount of naphthenes and/or paraffins that are not exposed to later reforming stages, and therefore cannot be processed to provide additional octane improvement.

In some aspects, minor flow channels can be included in the vessel 100 to further enhance the efficiency of the gas separation process. The minor flow channels can increase the surface area exposure of the adsorbent material along the rods 215.

FIG. 2B provides an exploded view of the adsorbent bed 200 of FIG. 2A. The adsorbent bed 200 is cut across the optional second gas outlet 120. The major flow channels 210 running through the adsorbent bed 200 are again seen. In addition, a transverse flow channel is seen at 220. The transverse flow channel 220 is a channel corresponding to temperature gas purge inlet 120 in FIG. 1. The transverse flow channel 220 serves as a minor flow channel. The flow channel 220 is seen partially extending into the adsorbent bed 200. However, the transverse flow channel 220 may optionally extend most of the way around the circumference of the annular adsorbent ring 205.

In the arrangement of FIG. 2B, only a single minor flow channel 220 is shown. However, the adsorbent bed 200 may have a plurality of minor flow channels 220. These may optionally be manifolded together with flow converging on the second gas outlet 120.

FIG. 2C is a longitudinal cross-sectional view of the adsorbent bed 200 of FIG. 2A. The view is cut through line C-C of FIG. 2A. Longitudinal adsorbent rods 215 are seen in FIG. 2C. In addition, major flow channels 210 are visible between the rods 215.

A series of stepped surfaces 225 are seen along the adsorbent rods 215. The stepped surfaces 225 can also serve as minor flow channels. In lieu of stepped surfaces 225, the surfaces 225 may be helical or spiraled surfaces. In any arrangement, the stepped surfaces 225 may be used in addition to or in lieu of the transverse channel 220 to increase surface area and improve kinetic selectivity without need of large and expensive heat transfer units.

The major 210 and minor 220, 225 flow channels provide paths in the contactor 200 through which gas may flow. Generally, the flow channels 210, 220, 225 provide for relatively low fluid resistance coupled with relatively high surface area. Flow channel length should be sufficient to provide the desired mass transfer zone, which is, at least, a function of the fluid velocity and the ratio of surface area to channel volume.

The flow channels 210, 220, 225 are preferably configured to minimize pressure drop in the vessel 100. Thus, tortuous flow paths are minimized or avoided. If too much pressure drop occurs across the bed 200, then higher cycle frequencies, such as on the order of greater than 100 cpm, are not readily achieved. In addition, it is preferred that the rods 215 be equidistantly spaced so as to create a degree of channel uniformity.

In one aspect, the flow channels 210 are generally divided so that there is little or no cross-flow. In this instance, a fluid flow fraction entering a channel 210 at the first end 102 of the contactor 100 does not significantly communicate with any other fluid fraction entering another channel 210 at the first end 102 until the fractions recombine upon exiting at the second end 104. In this arrangement, the volumes of the major flow channels 210 will be substantially equal to ensure that substantially all of the channels 210 are being fully utilized, and that the mass transfer zone defined by the interior volume of the contactor vessel 100 is substantially equally contained.

The dimensions of the flow channels 210 can be computed from considerations of pressure drop along the contactor vessel 100. It is preferred that the flow channels 210 have a channel gap from about 5 to about 1,000 microns, preferably from about 50 to about 250 microns. As utilized herein, the “channel gap” of a flow channel 210 is defined as the length of a line across the minimum dimension of the flow channel 210 as viewed orthogonal to the flow path. For instance, if the flow channel 210 is circular in cross-section, then the channel gap is the internal diameter of the circle. However, if the channel gap is rectangular in cross-section, the flow gap is the distance of a line perpendicular to and connecting the two longest sides of the rectangular (i.e., the length of the smallest side of the rectangle).

It should be noted that the major flow channels 210 can be of any cross-sectional configuration or geometric profile. In FIGS. 2A and 2B, the major flow channels 210 are star-shaped. Regardless of the shape, it is preferred that the ratio of the volume of adsorbent material to the flow channel volume in the adsorbent contactor 100 be from about 0.5:1 to about 100:1, and more preferably from about 1:1 to about 50:1.

In some pressure swing applications, particularly with RCPSA applications, the flow channels are formed when adsorbent sheets are laminated together. The flow channels within the sheets will contain a spacer or mesh that acts as a spacer. However, the spacers take up much-needed space. Therefore, laminated sheets are not desirable in the present contactor 100 and associated processes.

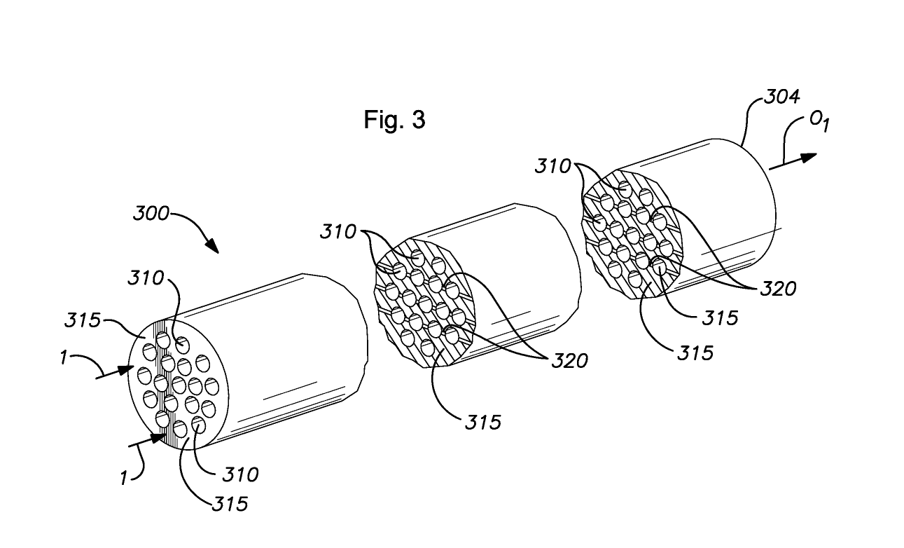

In lieu of laminated sheets, a plurality of small, transverse minor flow channels may be machined through the adsorbent rods. FIG. 3 provides a perspective view of an adsorbent bed 300 for the pressure swing adsorption vessel of FIG. 1, in a modified arrangement. The adsorbent bed 300 has an outer surface 305. The outer surface 305 is dimensioned to fit along an inner diameter of the housing 105 of the vessel 100 of FIG. 1.

Major flow channels 310 are provided within a monolithic adsorbent material 315. The major flow channels 310 are formed along a major axis of the adsorbent bed 300. However, to further increase surface area along the adsorbent rods, small transverse channels 320 are formed through the monolithic material 315. These channels serve as minor flow channels 320.

The minor flow channels 320 may be very small tubular channels, having a diameter of less than about 25 microns, for example. The minor flow channels 320 are not so large as to completely sever an adsorbent rod 315. In this way, the need for supporting spacers is avoided.

The minor flow channels 320 facilitate pressure balancing between the major flow channels 310. Both productivity and gas purity may suffer if there is excessive channel inconsistency. In this respect, if one flow channel is larger than an adjacent flow channel or receives more gas stream than another, premature product break-through may occur. This, in turn, leads to a reduction in the purity of the product gas to unacceptable purity levels. Moreover, devices operating at cycle frequencies greater than about 50 cycles per minute (cpm) require greater flow channel uniformity and less pressure drop than those operating at lower cycles per minute.

Returning now to FIGS. 1 and 2, the vessel 100 in FIG. 1 is shown as a cylinder, and the adsorbent rods 215 therein are shown as tubular members. However, other shapes may be employed that are suitable for use in swing adsorption process equipment. Non-limiting examples of vessel arrangements include various shaped monoliths having a plurality of substantially parallel channels extending from one end of the monolith to the other; a plurality of tubular members; stacked layers of adsorbent sheets with spacers between each sheet; multi-layered spiral rolls or bundles of hollow fibers, as well as bundles of substantially parallel solid fibers.

### Temperature Purging of Adsorbent

Due to the large heat of adsorption of single-ring aromatics, separating aromatics from an intermediate reformer effluent using a swing adsorber can result in large temperature changes in the adsorbent bed. Aromatics can be present in an intermediate reformer effluent in an amount of from 10 wt % to 30 wt %, or possibly more. Adsorbing this amount of aromatics from the intermediate reformer effluent can result in temperature increases for portions of the adsorbent bed of 10° C. to 80° C., or possibly still higher. This temperature rise for a given swing adsorber unit can vary in part based on the starting temperature of the adsorbent bed. As the temperature of the adsorbent bed increases, the amount of adsorption of aromatics by the adsorbent can increase. If sufficient adsorption of aromatics occurs, the temperature in portions of the adsorbent bed can become high enough to prevent further adsorption.

During adsorption, the temperature profile within the adsorbent bed can move in a manner similar to a wave front. When an aromatic-containing stream is introduced into the adsorbent bed, the initial portions of the adsorbent bed will heat only modestly. This can saturate the initial portions of the adsorbent, so that additional adsorption of aromatics occurs further along the axis of the reactor. As adsorption continues, the amount of heat evolved due to adsorption will continue to increase, resulting in an increase in the temperature of the adsorbent bed along the direction of travel of the aromatics-containing stream during adsorption. As still further aromatics are adsorbed, the temperature at a downstream location within the adsorbent bed will become high enough to reduce or minimize further aromatics adsorption.

After the adsorption portion of the adsorption cycle is over, desorption of the adsorbed aromatics can be facilitated by both decreasing the pressure of the adsorbent bed and further increasing the temperature of the adsorbent bed. In a traditional pressure swing adsorption process, a combination of a decreased pressure and a purge gas can be used to desorb the adsorbed components from the adsorbent bed. However, due in part to the high heat of adsorption of aromatics, desorbing such aromatics can substantially reduce the temperature of the adsorbent bed. This cooling of the adsorbent bed during desorption can potentially limit the amount of desorption that can occur, thus preventing the ability to fully regenerate the adsorbent bed.

The cooling during desorption of the aromatics can be mitigated, at least in part, by adding a heated purge gas during the desorption step. The heated purge gas can allow the adsorbent bed to maintain the desired desorption temperature in spite of the cooling due to desorption.

Similarly, during the adsorption process, a cooling purge gas could be introduced into the adsorbent bed to increase the amount of aromatics that can be absorbed prior to the adsorbent bed reaching the temperature limit where further adsorption does not occur. In other words, the location in the adsorbent bed where the temperature prevents adsorption can be moved further downstream by cooling the adsorbent bed during the aromatics adsorption process.

In some aspects, a temperature purge gas inlet that is intermediate to the inlets and outlets at the end of the swing adsorber can be used to provide additional control over the temperature in at least a portion of the adsorbent bed. It has unexpectedly been found that substantial energy savings can be achieved by introducing the temperature purge gas at an intermediate location in the adsorbent bed.

As noted above, the temperature profile of the adsorbent bed during an adsorption step can have the appearance of a rising wave front. Based on this profile, the temperature at the entry location of the aromatics-containing stream to the adsorbent bed can correspond to the lowest temperature, while the highest temperature will correspond to an intermediate location where adsorption reached a reduced or minimized level that corresponded to the end of the adsorption step.

When attempting to use a temperature purge gas during desorption, this temperature profile can pose some difficulties. In order to reduce or minimize the amount of desorbed aromatics that exit from the reactor via the product end, it can be desirable to perform the purge in a counter-current manner. Introducing a temperature purge gas in a counter-current manner into the adsorbent bed can mean that the hot temperature purge gas will be used to increase the temperature of the entire adsorbent bed. However, the portion of the adsorbent bed that benefits the most from the hot temperature purge gas can correspond to the initial portions of the adsorbent bed. When a conventional counter-current temperature purge gas is used, the initial portions of the bed are the last portions of the adsorbent bed that are heated. The net result is that the entire adsorbent bed is heated. Similarly, cooling the entire adsorbent bed can also be inefficient as only a portion of the adsorbent bed may be participate in equilibrium adsorption of aromatics.

In order to overcome the above difficulties, a hot temperature purge gas and/or a cold temperature purge gas can be introduced into the swing adsorber reactor at an intermediate location. During desorption, this can allow the hot temperature purge gas to be introduced selectively into only an initial portion of the adsorbent bed. This can reduce or minimize energy loss due to heating of the higher temperature portions of the adsorbent bed and/or heating of portions of the adsorbent bed that were beyond the location where adsorption was stopped. After desorption and prior to aromatics adsorption, introducing a cold temperature purge at an intermediate location can reducing or minimize energy usage by cooling only portions of the adsorbent bed that participate in equilibrium adsorption.

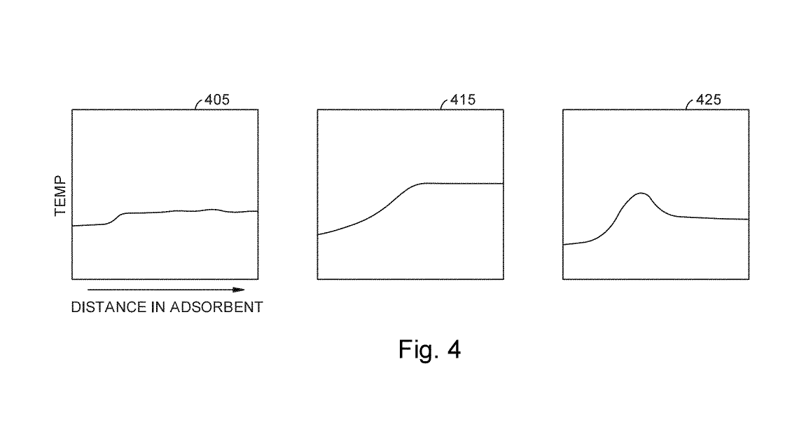

FIG. 4 schematically shows examples of the temperature profile at various times during a swing adsorption process for adsorption of aromatics. The profiles in FIG. 4 correspond to the expected profiles for introducing gases only through the ends of the swing adsorber vessel. The profiles represented in FIG. 4 are intended to be representative of the temperature profile at the start of adsorption 405 in a swing adsorption cycle; at or near the end of adsorption 415 in a swing adsorption cycle, and during the desorption portion 425 of the swing adsorption cycle. For the temperature profiles in FIG. 4, the x-axis corresponds to length of the adsorbent bed along the direction of flow of the intermediate reformer effluent. The y-axis corresponds to temperature. The profiles are representative, and therefore units/values are not provided.

In the example shown in FIG. 4, at the start of adsorption 405, the adsorbent bed has a relatively uniform temperature. Depending on the aspect, other temperature profiles could be present, but the general trends shown in FIG. 4 would still apply. As adsorption occurs, the initial portions of the adsorbent bed will saturate, so that the portion of the bed adsorbing the aromatics will move farther downstream. Additionally, as adsorption occurs, heat will be evolved due to desorption. This will result in heating of downstream portions of the adsorbent bed, with the temperature increasing more at locations that are farther downstream. Eventually, a downstream portion of the bed can reach a temperature where additional adsorption is not favored. At this point, the prior portions of the adsorbent bed can be substantially saturated to relative to the temperature profile a given location. Diagram 415 shows the temperature profile for the adsorbent bed at a time near the end of the adsorption step.

Although the adsorption step of a swing adsorption cycle could theoretically be performed until no further adsorption occurs, as a practical matter the swing adsorption cycle is usually stopped prior to the point where no further adsorption can occur. This can reduce or minimize the likelihood of breakthrough of additional aromatics into the aromatics-lean product stream. After the adsorption step ends, a desorption or purge step can be initiated. Some desorption can be induced by reducing the pressure in the vessel. However, due to the large amount of heat needed to desorb the aromatics, additional desorption of aromatics can be facilitated by modifying the temperature during desorption. The temperature modification can be performed, for example, by adding a heated purge stream during desorption. Diagram 425 shows the temperature profile for introducing a counter-current heated purge stream into the vessel during desorption. In the example shown in diagram 425, the heated purge stream can help to maintain a higher temperature in the adsorbent bed during desorption. Optionally, the temperature could be further increased during desorption based on the use of a heated purge stream.

The diagrams in FIG. 4 can also illustrate the difficulties with introducing streams for temperature control from the ends of the adsorbent bed. During an adsorption step, the coldest parts of the adsorbent bed are the portions of the bed closest to the feed inlet. Based on the temperature profile in diagram 405, if a cooling stream is introduced into the adsorbent bed via the end of the bed during the adsorption step, a portion of the temperature reduction will occur in the early parts of the bed where it is not fully necessary. Similarly, based on the temperature profile in diagram 415, if a heated steam is introduced into the adsorbent bed via the opposite end during desorption, a portion of the heat will be consumed by the portions of the bed that are already at higher temperatures.

To overcome this difficulty, temperature control purge streams can be introduced at an intermediate location in the adsorbent bed. During desorption, this can allow at least a portion of a heated temperature purge stream to be introduced into the portions of the adsorbent bed that have the coldest temperatures while avoiding excess heating of the portions of the adsorbent bed with higher temperatures. During adsorption, this can allow a cooling temperature stream to be introduced at a location so that the fully saturated initial portions of the bed are not further heated.

### Example Configuration for Rapid Cycle Swing Adsorption

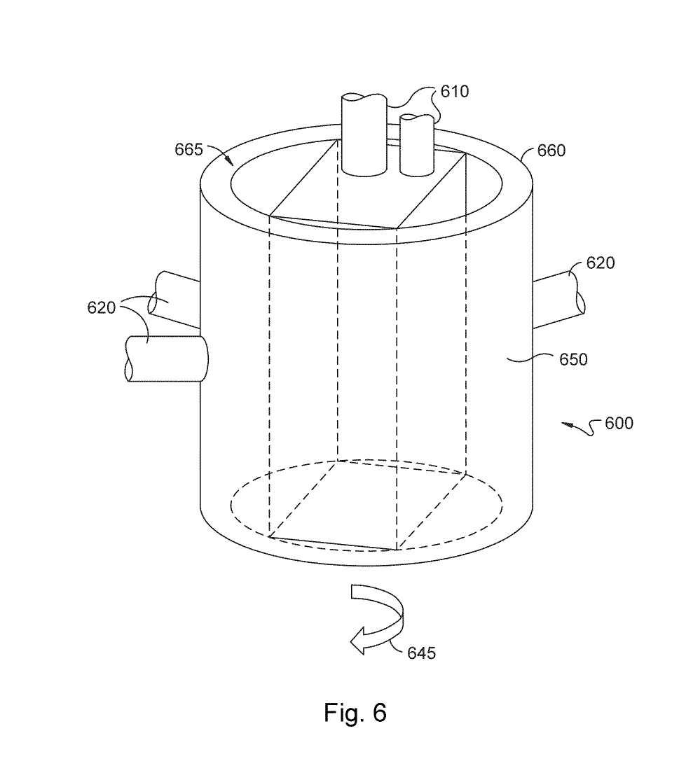

FIGS. 6-8 show an example of a reactor and adsorbent bed configuration that can be used to perform pressure and/or temperature swing adsorption as described herein. In particular, a configuration such as the configuration shown in FIGS. 6-8 can be beneficial for performing a rapid cycle swing adsorption process. The configuration shown in FIGS. 6-8 allows for rotation of the adsorbent bed, along with rotation of an axial and cylindrical rotor. This can allow the input flows into the bed and the output flows from the bed to be controlled based on the speed of rotation of the rotors. The axial and cylindrical rotors can include openings that allow fixed input ports to be opened or closed depending on whether the openings are at least partially aligned with a corresponding port. One benefit of the configuration shown in FIGS. 6-8 is that a cylindrical rotor is used to allow ports at intermediate locations in the adsorbent bed to be used for introducing gas streams. Thus, instead of just selecting an input or output action at the end of the adsorbent bed based on rotation, intermediate introduction and/or withdrawal of gas streams can also be performed based on rotation. This corresponds to the cylindrical rotor openings providing intermittent fluid communication between an intermediate input/output port and an intermediate location of the adsorbent bed. This is in contrast to a non-rotating configuration, where continuous fluid communication between an input port and an adsorbent bed would be present, and the gas flows would be controlled by use of valves (or another method). Similarly, axial rotors can allow the introduction and/or withdrawal of gases from one or both ends of the adsorbent bed to be controlled based on alignment of axial rotor openings within axial ports.

FIG. 6 shows a perspective view of an example of a swing adsorber reactor vessel and adsorbent bed. In FIG. 6, an adsorbent bed 650 is contained within a reactor (or vessel) 600. The reactor 600 in FIG. 6 includes a cylindrical rotor 665 and a cylindrical stator 660. The adsorbent bed 650 can rotate around axis 645 in conjunction with rotation of cylindrical rotor 665. The input ports 610 correspond to axial input ports for introduction and/or withdrawal of gases at the end of the adsorbent bed 650. The side ports 620 correspond to intermediate ports for introduction and/or withdrawal of gases at intermediate locations in adsorbent bed 650. As shown in FIG. 6, the location of the side ports 620 may not be symmetrical, as different types of gas flows may be desired at different times during a swing adsorption cycle.

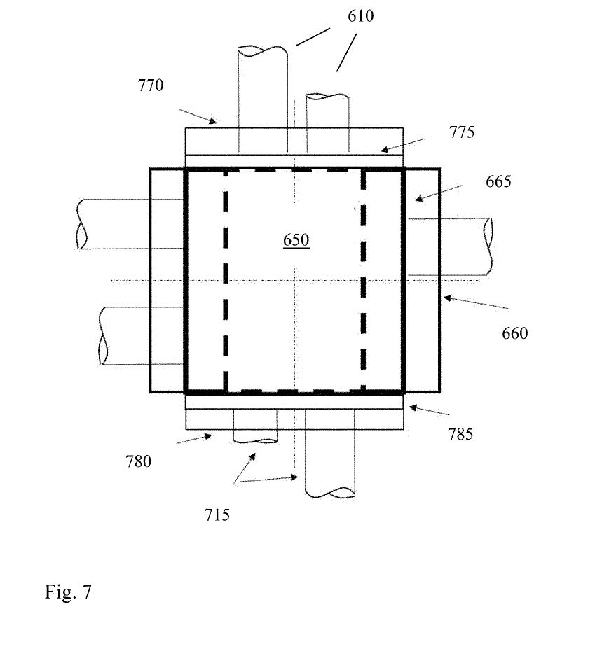

Additional details of the reactor 600 are shown in FIG. 7. In FIG. 7, an axial stator 770 and corresponding axial rotor 775 are also shown, along with the cylindrical rotor 665 and cylindrical stator 660. The axial rotor can move in conjunction with adsorbent bed 650 and cylindrical rotor 665. In FIG. 7, in addition to axial input ports 610, additional axial ports 715 are shown to allow for input and/or output from both ends of the adsorbent bed 650. The additional axial ports 715 are part of an additional axial stator 780, with a corresponding additional axial rotor 785.

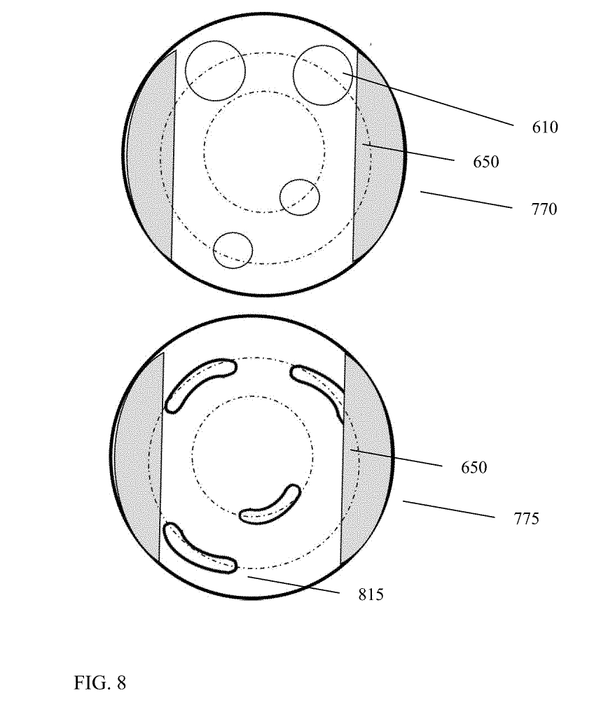

Further details regarding the axial rotor and stator are shown in FIG. 8. In FIG. 8, the top axial stator 770 and top axial rotor 775 are further illustrated. The top axial stator 770 includes axial input ports 610. The outline of adsorbent bed 610 is also indicated. The axial rotor 775 includes slots 815 that can rotate under the axial ports 710 to allow passage of gas into adsorbent bed 650 and/or withdrawal of gas from adsorbent bed 650. It is noted that the slots 815 will typically not be symmetrical, as different time lengths will often be desirable for the various input and output flows during a swing adsorption cycle.

In aspects where the reactor configuration includes both an axial rotor and a cylindrical rotor, the axial rotor and the cylindrical rotor can be operated synchronously or asynchronously. In some aspects, the axial rotor and the cylindrical rotor can have the same angular speed, so that the relative alignment of openings in the cylindrical rotor and the axial rotor is maintained during rotation. In other aspects, the angular speed of the cylindrical rotor and the axial rotor can differ in any convenient manner. Thus, the angular speed of the cylindrical rotor could be faster or slower than the angular speed of the axial rotor. It is noted that synchronous operation of the axial rotor and cylindrical rotor could still involve the rotors operating at different angular speeds. For example, synchronous operation of the cylindrical rotor and angular rotor could correspond to one rotor having an angular speed that is a whole number multiple of the speed of the other rotor (with the whole number being 10 or less), such as having the cylindrical rotor operate with twice the angular speed of the axial rotor. Asynchronous operation of the rotors refers to aspects where the relative speed of the rotors does not correspond to synchronous operation. Angular speed is defined as a speed expressed as a rotational frequency, such as a number of revolutions per second, degrees per second, or radians per second.

### Naphtha Reforming Conditions

Feedstocks which are suitable for reforming in accordance with the instant invention are any hydrocarbonaceous feedstocks boiling in the gasoline range. Non-limiting examples of such feedstocks include the light hydrocarbon oils boiling from about 70° F. (˜20° C.) to about 500° F. (˜260° C.), preferably from about 180° F. (˜80° C.) to about 400° F. (˜204° C.), for example straight run naphtha, synthetically produced naphtha such as a coal or oil-shale derived naphtha, thermally or catalytically cracked naphtha, hydrocracked naphtha, or blends or fractions thereof.

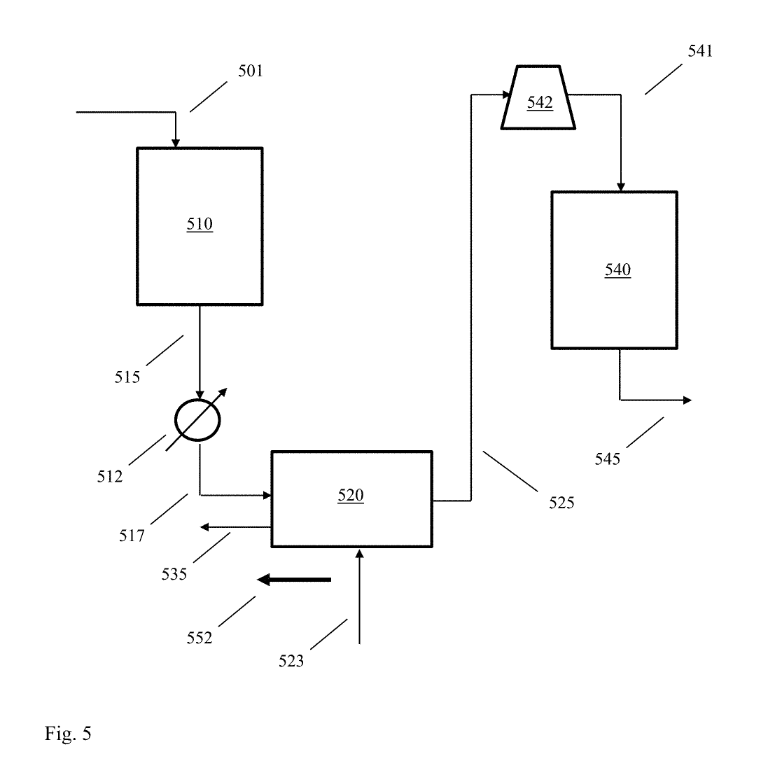

Referring to FIG. 5, a feedstock 501, which preferably is first hydrotreated by any conventional hydrotreating method to remove undesirable components such as sulfur and nitrogen, is passed to a first reforming stage 510. The first reforming stage can include one or more reactors. A reforming stage, as used herein, is any one or more reactors and its associated equipment (e.g., preheat furnaces etc.) separated from an immediately preceding or succeeding stage by the separation of aromatics from the reaction stream of the preceding stage. Feedstock 501 can be heated to an effective reforming temperature for reforming prior to entering first reforming stage 510. That is, to a temperature high enough to initiate and maintain dehydrogenation reactions, but not so high as to cause excessive hydrocracking. The reactor(s) in reforming stage 510 can include a catalyst (such as a catalyst system) suitable for reforming. Typical reforming operating conditions that can be used for any of the reactors of any of the stages hereof are such that the reactor inlet temperature is from about 800° F. (˜425° C.) to about 1200° F. (˜650° C.); the reactor pressure from about 30 psig (˜200 kPa-g) to about 1,000 psig (˜7000 kPa-g), or about 30 psig (˜200 kPa-g) to about 500 psig (˜3500 kPa-g); a weight hourly space velocity (WHSV) of about 0.5 hr⁻¹ to about 20 hr⁻¹, preferably from about 1 hr⁻¹ to about 10 hr⁻¹; and a hydrogen to oil ratio of about 1 to 10 moles of hydrogen per mole of C₅⁺ feed.

The intermediate reformer effluent 515 from reactor 510 can then be passed into a cooler 512 (such as a heat exchanger) to reduce the temperature of the effluent to a desired input temperature for removal of aromatics in swing adsorber 520, such as a temperature of about 100° C. to about 180° C., or about 120° C. to about 160° C. This can produce a cooled intermediate reformer effluent 517. Optionally, either the intermediate reformer effluent or the cooled intermediate reformer effluent can undergo a gas-liquid separation (not shown) to remove a gaseous stream from a heavier liquid stream. The gaseous stream, which is hydrogen-rich, can be recycled to a reforming stage, such as reforming stage 510.

The cooled intermediate reformer effluent 517 can then be passed into swing adsorption unit 520 for separation of aromatics. The swing adsorption unit 520 can include an optional intermediate purge gas inlet 523 to allow for introduction of hot temperature purge gas and/or cold temperature purge gas into the swing adsorption unit. The swing adsorption unit 520 can generate an aromatics-rich stream 535 during regeneration of the adsorbent bed. This aromatics-rich stream can correspond to a higher octane naphtha stream that is suitable for introduction into a gasoline pool. The swing adsorption unit 520 can produce an aromatics-lean product 525 that can be heated prior to entering second reforming stage 540. FIG. 5 shows a heater 542, but it is understood that any convenient combination of heaters and/or heat exchangers can be used. Second reforming stage 540 can then be used to perform further reforming on the aromatics-lean product. It is noted that FIG. 5 shows two reforming stages. In various aspects, any convenient number of reforming stages can be used, with separation via swing adsorption optionally used between each stage.

FIG. 5 also schematically represents the benefits of using an optional intermediate purge gas inlet 523. When using intermediate purge gas inlet 523, the purge gas can travel over only a portion of the bed in the direction of large arrow 552 within swing adsorber unit 520. This can allow for selective heating and/or cooling of the portion of the bed that participates in equilibrium adsorption of aromatics. It is noted that the total length of an adsorbent bed is typically longer than the portion of the bed that participates in equilibrium adsorption, so that difficulties with breakthrough of aromatics into the aromatics-lean stream can be reduced or minimized.

Catalysts suitable for use herein include both monofunctional and bifunctional multimetallic Pt-containing reforming catalysts. Preferred are the bifunctional reforming catalysts comprised of a hydrogenation-dehydrogenation function and an acid function. The acid function, which is important for isomerization reactions, is thought to be associated with a material of the porous, adsorptive, refractory oxide type which serves as the support, or carrier, for the metal component, usually a Group VIII noble metal, to which is generally attributed the hydrogenation-dehydrogenation function. The support material may also be a crystalline aluminosilicate such as a zeolite. Non-limiting examples of zeolites which may be used herein include those having an effective pore diameter, particularly L-zeolites, zeolite X, and zeolite Y. Preferably the Group VIII noble metal is platinum. One or more promoter metals selected from metals of Groups IIIA, IVA, IB, VIB, and VIIB of the Periodic Table of the Elements may also be present. The promoter metal, can be present in the form of an oxide, sulfide, or elemental state in an amount from about 0.01 to about 5 wt. %, preferably from about 0.1 to about 3 wt. %, and more preferably from about 0.2 to about 3 wt. %, calculated on an elemental basis, and based on the total weight of the catalyst composition. It is also preferred that the catalyst compositions have a relatively high surface area, for example, about 100 to 250 m²/g. The Periodic Table of which all the Groups herein refer to can be found on the last page of Advanced Inorganic Chemistry, 2nd Edition, 1966, Interscience Publishers, by Cotton and Wilkinson.

The halide component which contributes to the necessary acid functionality of the catalyst may be fluoride, chloride, iodide, bromide, or mixtures thereof. Of these, fluoride and, particularly, chloride are preferred. Generally, the amount of halide is such that the final catalyst composition will contain from about 0.1 to about 3.5 wt. %, preferably about 0.5 to about 1.5 wt. % of halogen calculated on an elemental basis.

Preferably, the platinum group metal will be present on the catalyst in an amount from about 0.01 to about 5 wt. %, calculated on an elemental basis, of the final catalytic composition. More preferably the catalyst comprises from about 0.1 to about 2 wt. % platinum group component, especially about 0.1 to 2 wt. % platinum. Other preferred platinum group metals include palladium, iridium, rhodium, osmium, ruthenium and mixtures thereof.

In some aspects, performing intermediate aromatics separation during multistage reforming can allow the reforming to be conducted more efficiently and/or with increased hydrogen and C₅⁺ liquid yields. For example, performing intermediate aromatics separation can allow the reactors upstream of aromatics separation to be operated at conventional reforming temperatures and pressures while the reactors downstream of the aromatics removal, because of the removal of a substantial portion of feed as an aromatics-rich stream, can be operated at lower pressures. In some aspects, the pressures in the second reforming stage can be as low as from about 30 psig (˜200 kPa-g) to about 200 psig (˜1400 kPa-g), or about 30 psig (˜200 kPa-g) to about 100 psig (˜700 kPa-g). Additionally or alternately, because of the removal of this aromatics-rich stream, the reactors downstream to its removal can be operated without recycling hydrogen-rich make-gas. That is, the downstream reactors can be operated in once-through hydrogen-rich gas mode because a sufficient amount of hydrogen is generated in the downstream reactors, that when combined with the hydrogen-rich gas from the reactors of the previous stage, there is an adequate amount of hydrogen to sustain the reforming reactions taking place in the downstream reactors.

The pressure drop in the downstream reactors can be reduced by operating in the once-through hydrogen-rich gas mode, thereby allowing for a smaller product-gas compressor (C₂ in the Figure) than would otherwise be required. Furthermore, operating in a once-through hydrogen-rich gas mode also eliminates the need for a recycle gas compressor to circulate the hydrogen-rich make-gas in the downstream reactors.

Further additionally or alternately, by operating the downstream reactors at lower octane severity, one is able to achieve lower coking rates, and thus longer catalyst life between regenerations. This lower severity also can also results in less undesirable polynuclear aromatic side products.

### Additional Embodiments

### Embodiment 1

A method for catalytically reforming a naphtha boiling range hydrocarbonaceous feedstock, comprising: exposing a naphtha boiling range feedstock to a first reforming catalyst under first reforming conditions to form an intermediate reformer effluent comprising aromatics; passing at least a portion of the intermediate reformer effluent into a vessel comprising an adsorbent bed; adsorbing, during an adsorbing step of a swing adsorption process, at least a portion of the aromatics from the intermediate reformer effluent to form an aromatics-lean stream; exposing at least a portion of the aromatics-lean stream to a second reforming catalyst under second reforming conditions to form a second stage reformer effluent; and desorbing at least a portion of the adsorbed aromatics to form an aromatics-rich purge stream, the first reforming catalyst optionally being different from the second reforming catalyst.

### Embodiment 2

The method of Embodiment 1, wherein the intermediate reformer effluent comprises an aromatics content of 20 wt % to 40 wt %.

### Embodiment 3

The method of any of the above embodiments, wherein the aromatics-rich purge stream comprises about 70 wt % or more of aromatics (or about 75 wt % or more, or about 80 wt % or more); or wherein the aromatics-rich purge stream comprises about 70 wt % or more of the aromatics in the at least a portion of the intermediate reformer effluent (or about 75 wt % or more, or about 80 wt % or more); or a combination thereof.

### Embodiment 4

The method of any of the above embodiments, wherein the first reforming conditions comprise a reactor pressure of about 200 kPa-g to about 7000 kPa-g; or wherein the second reforming conditions comprise a reactor pressure of about 200 kPa-g to about 1400 kPa-g (or about 200 kPa-g to about 700 kPa-g); or a combination thereof.

### Embodiment 5

The method of any of the above embodiments, wherein the first reforming conditions, the second reforming conditions, or a combination thereof comprise a temperature of about 425° C. to about 650° C., a weight hourly space velocity (WHSV) of about 0.5 hr⁻¹ to about 20 hr⁻¹, and a hydrogen to oil ratio of about 1 to 10 moles of hydrogen per mole of C₅₊ feed.

### Embodiment 6

The method of any of the above embodiments, wherein adsorbing at least a portion of the aromatics from the intermediate reformer effluent comprises contacting the intermediate reformer effluent with the adsorbent bed at an adsorber inlet temperature of about 100° C. to about 200° C. (or about 120° C. to about 180° C.) and an adsorber inlet pressure of about 200 kPa-g to about 2000 kPa-g (or about 200 kPa-g to about 1400 kPa-g), an average temperature of the adsorbent bed optionally being greater than the adsorber inlet temperature during the adsorbing step.

### Embodiment 7

The method of any of the above embodiments, wherein desorbing at least a portion of the aromatics adsorbed by the adsorbent bed comprises reducing the adsorber inlet pressure to from about 200 kPa-g to about 700 kPa-g.

### Embodiment 8

The method of any of the above embodiments, wherein desorbing at least a portion of the aromatics comprises introducing a temperature purge gas at an intermediate location in the adsorbent bed relative to the ends of the adsorbent bed, the temperature purge gas being at a higher temperature than the temperature of the adsorbent bed at the intermediate location, the introducing the temperature purge gas at the intermediate location optionally comprising passing the temperature purge gas through a cylindrical port into an opening in a cylindrical rotor.

### Embodiment 9

The method of any of the above embodiments, the method further comprising introducing a cooling purge gas at the intermediate location a) after the desorbing and prior to a subsequent adsorbing, b) during adsorbing, or c) a combination thereof, the introducing the cooling purge gas at the intermediate location optionally comprising passing the cooling purge gas through a cylindrical port into an opening in a cylindrical rotor.

### Embodiment 10

The method of any of the above embodiments, wherein the swing adsorber process is performed in a reactor comprising an axial stator, an axial rotor, a cylindrical stator, and a cylindrical rotor, and wherein a) the axial rotor is operated synchronously relative to the cylindrical rotor during the adsorbing and the desorbing; b) the axial rotor is operated asynchronously relative to the cylindrical rotor during the adsorbing and the desorbing; c) the axial rotor and the cylindrical rotor are operated at different angular speeds during the adsorbing and the desorbing; or d) a combination of two or more of a), b) and c).

### Embodiment 11

A system for performing multi-stage naphtha reforming, comprising: a first reforming stage comprising a first reforming catalyst, a first reforming stage inlet, and a first reforming stage outlet; a swing adsorption stage comprising one or more swing adsorber vessels, the one or more swing adsorpber vessels comprising an adsorber inlet in fluid communication with the first reforming stage outlet, an adsorber outlet, an aromatics purge outlet, and an adsorbent bed, the aromatics purge outlet being in fluid communication with an intermediate location of the adsorbent bed; a second reforming stage comprising a second reforming catalyst, a second reforming stage inlet in fluid communication with the adsorber outlet and a second reforming stage outlet.

### Embodiment 12

The system of Embodiment 11, wherein the swing adsorption stage further comprises an intermediate purge inlet for introducing at least one of a temperature purge gas and a cooling purge gas into an intermediate location in at least one adsorbent bed in the one or more swing adsorber vessels, the one or more swing adsorber vessels optionally further comprising a cylindrical rotor comprising one or more cylindrical rotor openings, the intermediate purge inlet being in intermittent fluid communication with the adsorbent bed via the one or more cylindrical rotor openings.

### Embodiment 13

The system of Embodiment 11 or 12, wherein the one or more swing adsorber vessels further comprise an axial rotor comprising one or more axial rotor openings, the adsorber inlet being in fluid communication with the adsorbent bed via the one or more axial rotor openings, and optionally wherein a) the axial rotor is capable of synchronous operation relative to the cylindrical rotor, b) the axial rotor is capable of asynchronous operation relative to the cylindrical rotor, c) the axial rotor and the cylindrical rotor are capable of being operated at different angular speeds during operation of the swing adsorber bed, or d) a combination of two or more of a), b) and c).

### Embodiment 14

The system of any of Embodiments 11 to 13, wherein the adsorber inlet is in fluid communication with a first end of the adsorbent bed, or wherein the adsorber outlet is in fluid communication with a second end of the adsorbent bed, or a combination thereof.

### Embodiment 15

The method of any of Embodiments 1 to 10 or system of any of Embodiments 11 to 14, wherein the adsorbent bed comprises a zeolitic framework material, the zeolitic framework material optionally being bound by a mesoporous organosilica binder.

Although the present invention has been described in terms of specific embodiments, it is not so limited. Suitable alterations/modifications for operation under specific conditions should be apparent to those skilled in the art. It is therefore intended that the following claims be interpreted as covering all such alterations/modifications as fall within the true spirit/scope of the invention.

1. A method for catalytically reforming a naphtha boiling range hydrocarbonaceous feedstock, comprising:
exposing a naphtha boiling range feedstock to a first reforming catalyst under first reforming conditions to form an intermediate reformer effluent comprising aromatics;
passing at least a portion of the intermediate reformer effluent into a vessel comprising an adsorbent bed;
adsorbing, during an adsorbing step of a swing adsorption process, at least a portion of the aromatics from the intermediate reformer effluent to form an aromatics-lean stream;
exposing at least a portion of the aromatics-lean stream to a second reforming catalyst under second reforming conditions to form a second stage reformer effluent; and
desorbing at least a portion of the adsorbed aromatics to form an aromatics-rich purge stream.

2. The method of claim 1, wherein the intermediate reformer effluent comprises an aromatics content of 20 wt % to 40 wt %.

3. The method of claim 1, wherein the aromatics-rich purge stream comprises about 70 wt % or more of aromatics.

4. The method of claim 1, wherein the aromatics-rich purge stream comprises about 70 wt % or more of the aromatics in the at least a portion of the intermediate reformer effluent.

5. The method of claim 1, wherein the first reforming conditions comprise a reactor pressure of about 200 kPa-g to about 7000 kPa-g; or wherein the second reforming conditions comprise a reactor pressure of about 200 kPa-g to about 1400 kPa-g; or a combination thereof.

6. The method of claim 1, wherein the first reforming conditions, the second reforming conditions, or a combination thereof comprise a temperature of about 425° C. to about 650° C., a weight hourly space velocity (WHSV) of about 0.5 hr⁻¹ to about 20 hr⁻¹, and a hydrogen to oil ratio of about 1 to 10 moles of hydrogen per mole of C₅₊ feed.

7. The method of claim 1, wherein adsorbing at least a portion of the aromatics from the intermediate reformer effluent comprises contacting the intermediate reformer effluent with the adsorbent bed at an adsorber inlet temperature of about 100° C. to about 200° C. and an adsorber inlet pressure of about 200 kPa-g to about 2000 kPa-g.

8. The method of claim 7, wherein an average temperature of the adsorbent bed is greater than the adsorber inlet temperature during the adsorbing step.

9. The method of claim 1, wherein desorbing at least a portion of the aromatics adsorbed by the adsorbent bed comprises reducing the adsorber inlet pressure to from about 200 kPa-g to about 700 kPa-g.

10. The method of claim 1, wherein desorbing at least a portion of the aromatics comprises introducing a temperature purge gas at an intermediate location in the adsorbent bed relative to the ends of the adsorbent bed, the temperature purge gas being at a higher temperature than the temperature of the adsorbent bed at the intermediate location.

11. The method of claim 10, wherein introducing the temperature purge gas at the intermediate location comprises passing the temperature purge gas through a cylindrical port into an opening in a cylindrical rotor.

12. The method of claim 1, the method further comprising introducing, after the desorbing and prior to a subsequent adsorbing, a cooling purge gas at an intermediate location.

13. The method of claim 12, wherein introducing the cooling purge gas at the intermediate location comprises passing the cooling purge gas through a cylindrical port into an opening in a cylindrical rotor.

14. The method of claim 1, the method further comprising introducing, during adsorbing, a cooling purge gas at the intermediate location.

15. The method of claim 1, wherein the first reforming catalyst is different from the second reforming catalyst.

16. The method of claim 1, wherein the adsorbent bed comprises a zeolitic framework material.

17. The method of claim 16, wherein the zeolitic framework material is bound by a mesoporous organosilica binder.

18. The method of claim 1, wherein the swing adsorber process is performed in a reactor comprising an axial stator, and axial rotor, a cylindrical stator, and a cylindrical rotor, the axial rotor and the cylindrical rotor being operated at different angular speeds during the adsorbing and the desorbing.

19. The method of claim 1, wherein the swing adsorber process is performed in a reactor comprising an axial stator, and axial rotor, a cylindrical stator, and a cylindrical rotor, the axial rotor being operated synchronously relative to the cylindrical rotor during the adsorbing and the desorbing.

20. The method of claim 1, wherein the swing adsorber process is performed in a reactor comprising an axial stator, and axial rotor, a cylindrical stator, and a cylindrical rotor, the axial rotor being operated asynchronously relative to the cylindrical rotor during the adsorbing and the desorbing.

21. A system for performing multi-stage naphtha reforming, comprising:
a first reforming stage comprising a first reforming catalyst, a first reforming stage inlet, and a first reforming stage outlet;
a swing adsorption stage comprising one or more swing adsorber vessels, the one or more swing adsorber vessels comprising an adsorber inlet in fluid communication with the first reforming stage outlet, an adsorber outlet, an aromatics purge outlet, and an adsorbent bed, the aromatics purge outlet being in fluid communication with an intermediate location of the adsorbent bed;
a second reforming stage comprising a second reforming catalyst, a second reforming stage inlet in fluid communication with the adsorber outlet and a second reforming stage outlet.

22. The system of claim 21, wherein the swing adsorption stage further comprises an intermediate purge inlet for introducing at least one of a temperature purge gas and a cooling purge gas into an intermediate location in at least one adsorbent bed in the one or more swing adsorber vessels.

23. The system of claim 22, wherein the one or more swing adsorber vessels further comprise a cylindrical rotor comprising one or more cylindrical rotor openings, the intermediate purge inlet being in intermittent fluid communication with the adsorbent bed via the one or more cylindrical rotor openings.

24. The system of claim 23, wherein the one or more swing adsorber vessels further comprise an axial rotor comprising one or more axial rotor openings, the adsorber inlet being in fluid communication with the adsorbent bed via the one or more axial rotor openings.

25. The system of claim 24, wherein a) the axial rotor is capable of synchronous operation relative to the cylindrical rotor, b) the axial rotor is capable of asynchronous operation relative to the cylindrical rotor, c) the axial rotor and the cylindrical rotor are capable of being rotated at different angular speeds during operation of the swing adsorber bed, or d) a combination of two or more of a), b) and c).

26. The system of claim 21, wherein the adsorbent bed comprises a zeolitic framework material, or wherein the adsorbent bed comprises a zeolitic framework material bound by a mesoporous organosilica binder.

27. The system of claim 21, wherein the adsorber inlet is in fluid communication with a first end of the adsorbent bed, or wherein the adsorber outlet is in fluid communication with a second end of the adsorbent bed, or a combination thereof.
